(19) United States
(12) Patent Application Publication
(10) Pub. No.: US 2019/0219260 A1
(43) Pub. Date: Jul. 18, 2019

(54) FLASHING CONTAINER

(71) Applicant: Hua-Cheng Pan, Tainan City (TW)

(72) Inventor: Chih-Liang Wang, Tainan City (TW)

(21) Appl. No.: 15/869,104

(22) Filed: Jan. 12, 2018

(51) Int. Cl. F21V 33/00; B65D 25/54; A47G 7/06; F21V 23/04

(52) U.S. Cl. CPC F21V 33/0028; B65D 25/54; A47G 7/06; F21Y 2115/10; B65D 2203/00; A47G 2200/08; F21V 23/0407

(57) ABSTRACT

A flashing container includes: a translucent outer casing, and two sides thereof respectively having an opening both in communication with each other, and a wall surface of the outer casing configured with a first decorative pattern a hollow, translucent inner casing, a wall surface thereof encircling an accommodation space having a upper opening, the wall surface configured with a second decorative pattern, and the inner casing adapted to seal one of the openings of the outer casing; and a bottom seat, adapted to seal another opening of the outer casing and having a control circuit, at least two light sources in electric connection with the control circuit and a power portion for the power supply to each light source, and each light source respectively corresponding to bottoms of the outer, inner casings, and controlled by the control circuit to emit light intermittently toward the outer casing and inner casing.

### TECHNICAL FIELD OF THE INVENTION

The present invention relates to a container, and more particularly to a container structure with flickering lights.

### DESCRIPTION OF THE PRIOR ART

Modern life is busy, flower-related products are the best rest medium of exhaustion. Floral organs and flower arranging are closely related; beautiful flowers need a suitable floral organ to match therewith beyond question.

Conventional floral organs are usually made of ceramics, transparent glass, acrylic or metal, and the exteriors thereof are always decorated with various patterns or carving to make them more eye-appealing. However, the above floral organs are made of a single material such that they are little changeable such that there is no novelty on the long-term use and has no way to display the flourishing vigor of flowers. In addition, the monotonous floral organs are difficult to stimulate consumer desire to buy.

### SUMMARY OF THE INVENTION

The main object of the present invention is to provide a container design having flashing lighting, thereby increasing the novelty of the container and increasing product competitiveness.

To achieve the object mentioned above, the present invention proposes a flashing container, including: an outer casing, being pervious to light, and two sides thereof respectively having an opening, the both openings in communication with each other, and a wall surface of the outer casing configured with a first decorative pattern; an inner casing, being hollow and pervious to light, a wall surface thereof encircling an accommodation space having a upper opening, the wall surface configured with a second decorative pattern, and the inner casing fixed inside the outer casing and adapted to seal one of the openings of the outer casing; and a bottom seat, adapted to seal the opening on another side of the outer casing and having a control circuit, at least two light sources in electric connection with the control circuit and a power portion for the power supply to each light source, and each light source respectively corresponding to bottoms of the outer casing and inner casing, and controlled by the control circuit to emit light intermittently toward the outer casing and inner casing.

Therefore, the configuration of the bottom seat allows each light source to emit light intermittently to the bottoms of the outer casing and inner casing, and thus enabling the first and second decorative patterns to be brightened in sequence, thereby allowing the present invention to have a flashing effect and further promoting product novelty and competitiveness.

### BRIEF DESCRIPTION OF THE DRAWINGS

FIG. 1 is a perspective view of the present invention;

FIG. 2 is an exploded view of the present invention;

FIG. 3 is a cross-sectional view of FIG. 1 taken along line A-A;

FIG. 4 is a schematic view of the present invention in a use state;

FIG. 5 is an exploded view of a preferred embodiment of the present invention;

FIG. 6 is a cross-sectional view of FIG. 5;

FIG. 7 is an exploded view of another embodiment of the present invention;

FIG. 8 is a partly cross-sectional view of FIG. 7;

FIG. 9 is a partly cross-sectional view of still another embodiment of the present invention; and

FIG. 10 is a perspective view of the present invention viewing from below.

### DETAILED DESCRIPTION OF THE PREFERRED EMBODIMENTS

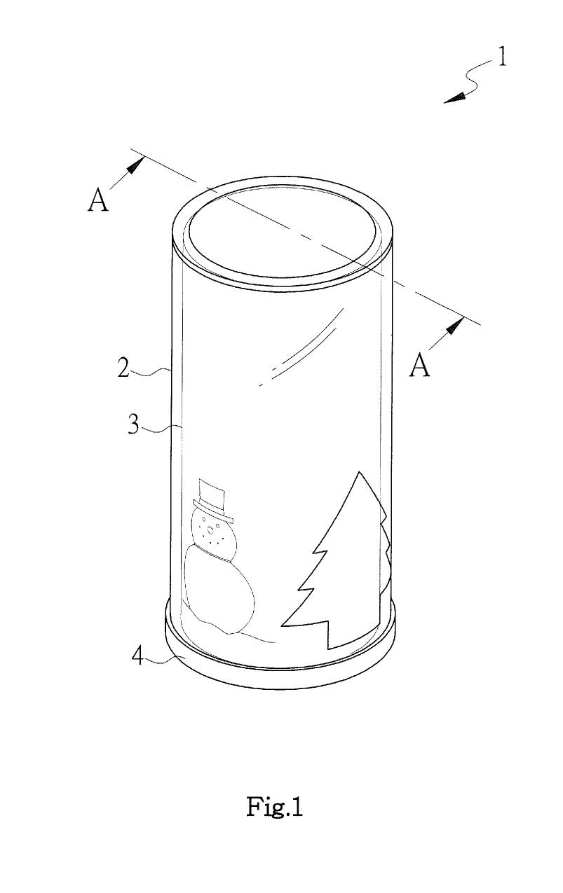

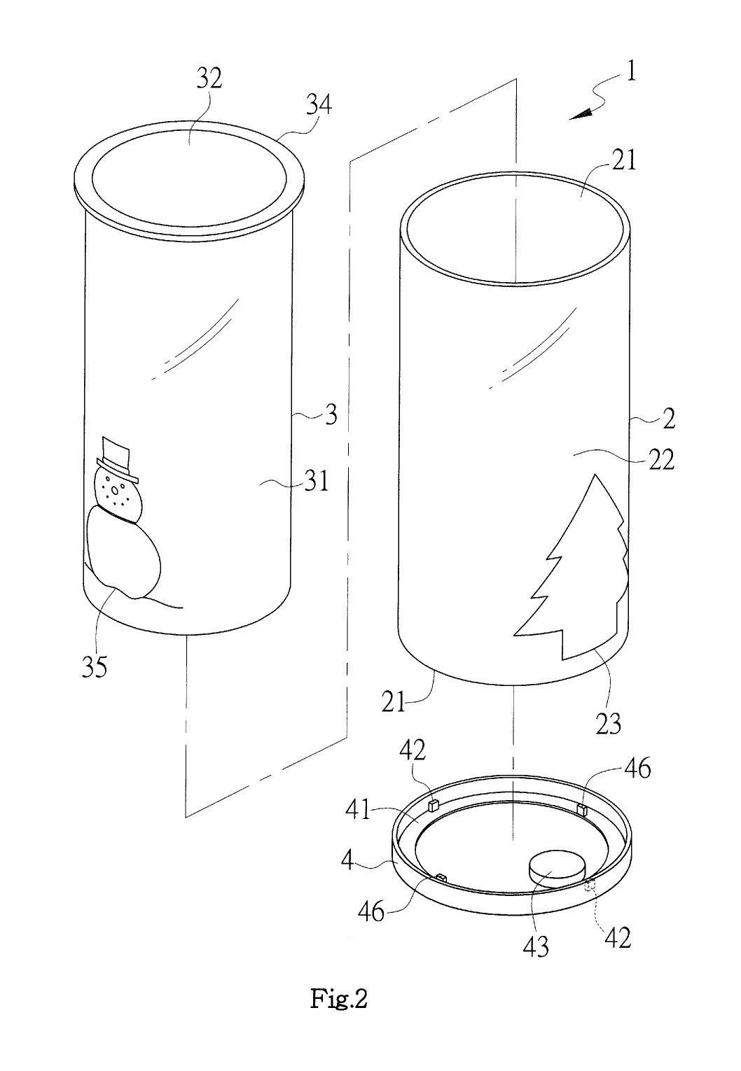

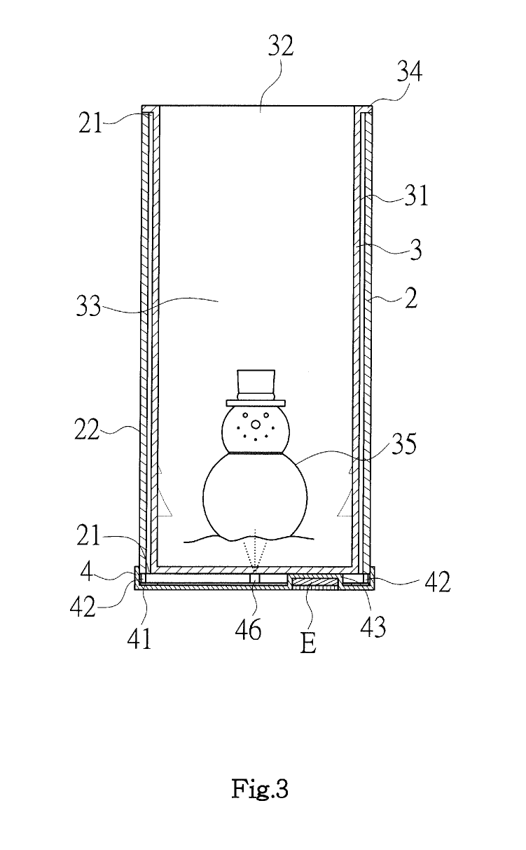

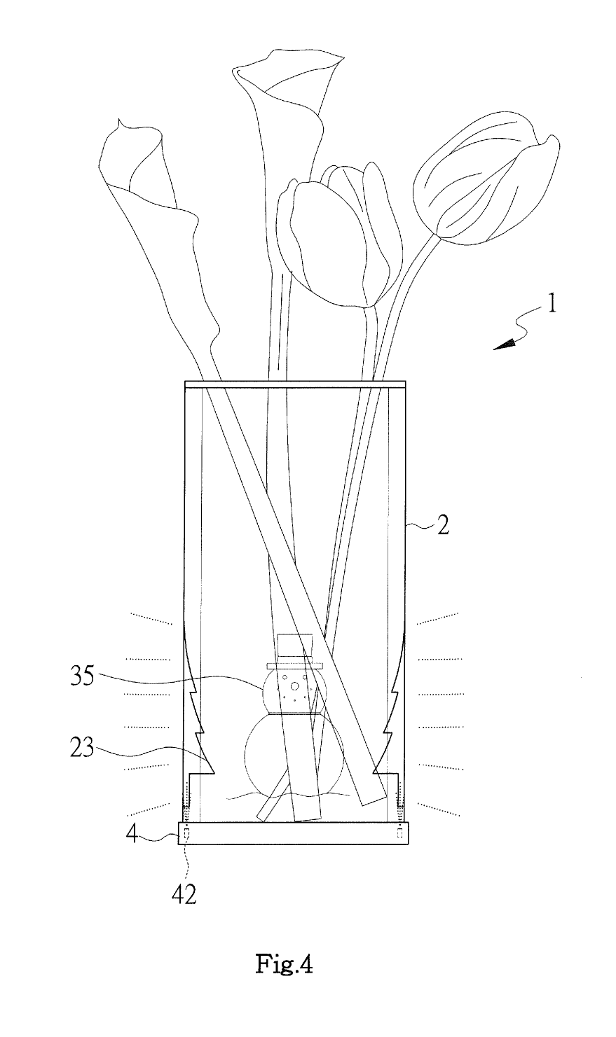

Referring to FIGS. 1 to 4, a flashing container 1 of the present invention mainly includes an outer casing 2, inner casing 3 and bottom seat 4, where the outer casing 2 encircles the outer edge of the inner casing 3, and the bottom seat 4 is configured on the bottom of the outer casing 2, where the outer casing 2 is hollow and pervious to light. The present invention does not limit the modeling of the outer casing 2 and describes it as a cylinder here, and does not limit the material of the outer casing 2 and all the materials pervious to light are within the scope of the present invention. The two sides of the outer casing 2 respectively have an opening 21 both in communication with each other. Furthermore, a wall surface 22 of the outer casing 2 is configured with a decorative pattern 23.

The inner casing 3 is hollow and pervious to light. The present invention does not limit the modeling of the inner casing 3 and describes it as a cup here, and does not limit the material of the outer casing 2 and all the materials pervious to light are within the scope of the present invention. Furthermore, a wall surface 31 of the inner casing 3 encircles an accommodation space having a upper opening 32, which is extended outward with an overlap 34. In the embodiment, the overlap 34 is circumferential along the opening 32, but the present invention is not so limited, where the inner casing 3 is assembled on the opening 21 on the one side of the outer casing 2 with the overlap 34 and thus adapted to close the opening 21, allowing the accommodation space 33 to be positioned inside the outer casing 2. In addition, the wall surface 31 of the inner casing 3 is configured with a second decorative pattern 35.

The bottom seat 4 is fixed on the lower side of the outer casing 2 and adapted to seal the opening 21 on another side of the outer casing 2. Furthermore, the bottom seat 4 has a control circuit 41, a plurality of light sources 42, 46 in electric connection with the control circuit 41 and a power portion 43 adapted to supply power to each light source 42, 46, where the power portion 43 is used for power supply, capable of the installment of a battery E or the power generation in other ways. Furthermore, each light source 42, 46 is configured correspondingly to the bottoms of the outer casing 2 and inner casing 3, and emits light intermittently toward the outer casing 2 and inner casing 3; the present invention does not limit the number of the light sources 42, 46, and it can be increased depending on design requirements. In the embodiment, the light sources 42, 46 respectively are a light emitting diode (LED), the light emitting time sequence, color change of which is controlled by the control circuit 41, and the light sources 42, 46 are preferably attached closely to the bottoms of the outer casing 2 and inner casing 2, allowing the light to penetrate therein directly.

Furthermore, the present invention does not limit the forms of the first decorative pattern 23 and second decorative pattern 35; they can be festive text, motif or geometry, mainly painted on the wall surface 22, 31 of the outer casing 2 and inner casing 3 with highlighters or fluorescent paints, or configured on each wall surface 22, 31 by means of carving.

As stated above, the accommodation space 33 of the inner casing 3 allows flowers to be inserted therein when the container 1 of the present invention is used as a floral organ. Furthermore, each light source 42, 46 emits light intermittently toward the outer casing 2 and inner casing 3 according to the time sequence set by the control circuit 41 when the power is on, allowing the first decorative pattern 23 and second decorative pattern 35 to be brightened due to the light, and at the same time the outer casing 2 and inner casing 3 are also changed in color due to the light, further promoting product novelty and competitiveness.

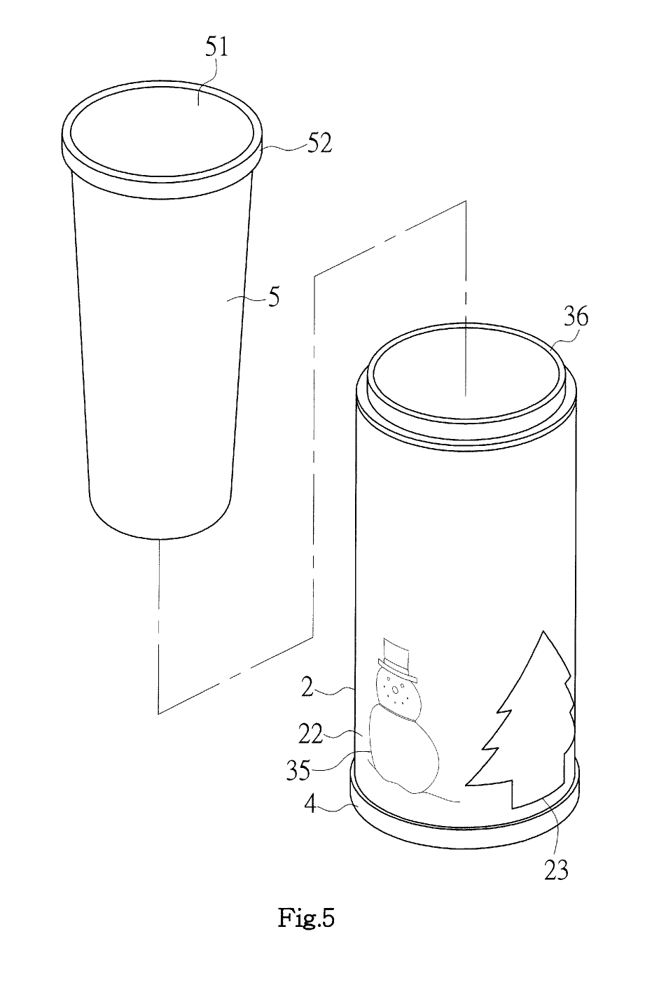

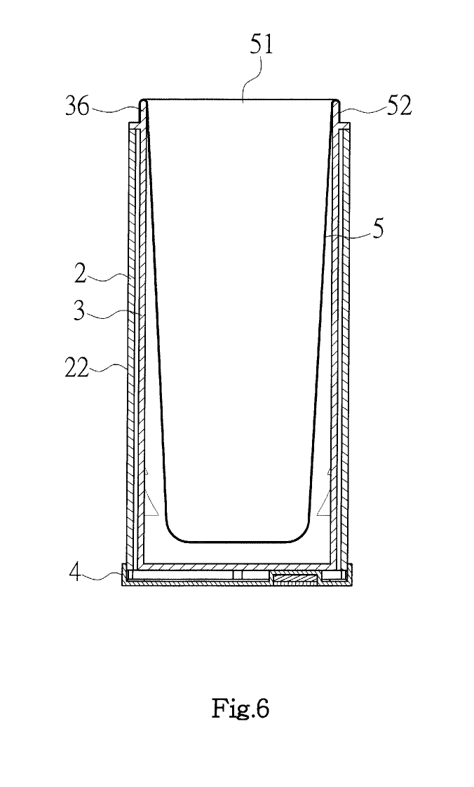

Next, referring to FIGS. 5 and 6, the container 1 of the present invention, in the embodiment, further includes a cup body 5, which is preferably made of stainless steel, but the present invention is not so limited. The cup body 5 has a upper opening 51, the peripheral of which is flanged outward with an engagement portion 52, and a projecting rib 36 corresponding to the engagement portion 52 is configured around the opening 32 of the inner casing 3, where the cup body 5 is in engagement with the projecting rib 36 of the inner casing 3 with the engagement portion 52, allowing the cup body 5 to be positioned inside the accommodation space 33, thereby enabling the container 1 to be formed into a tea cup.

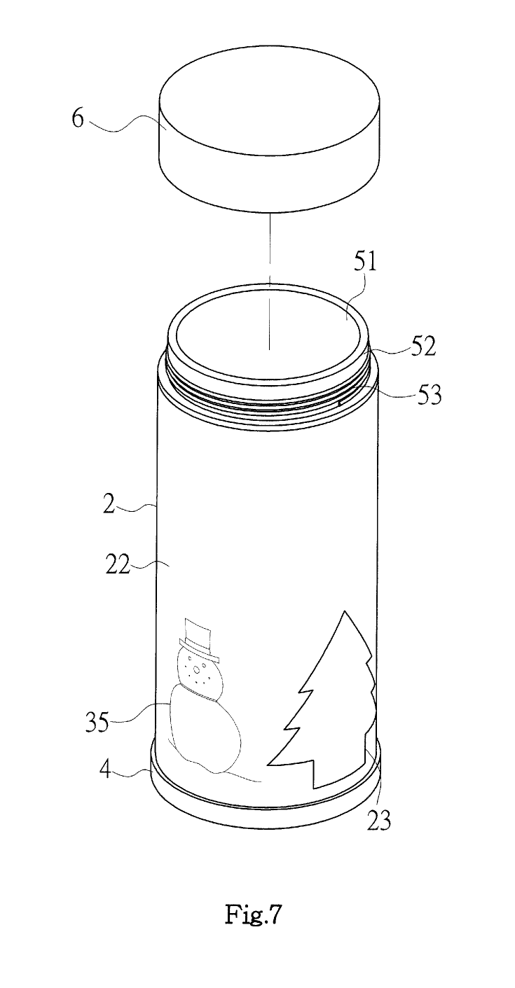

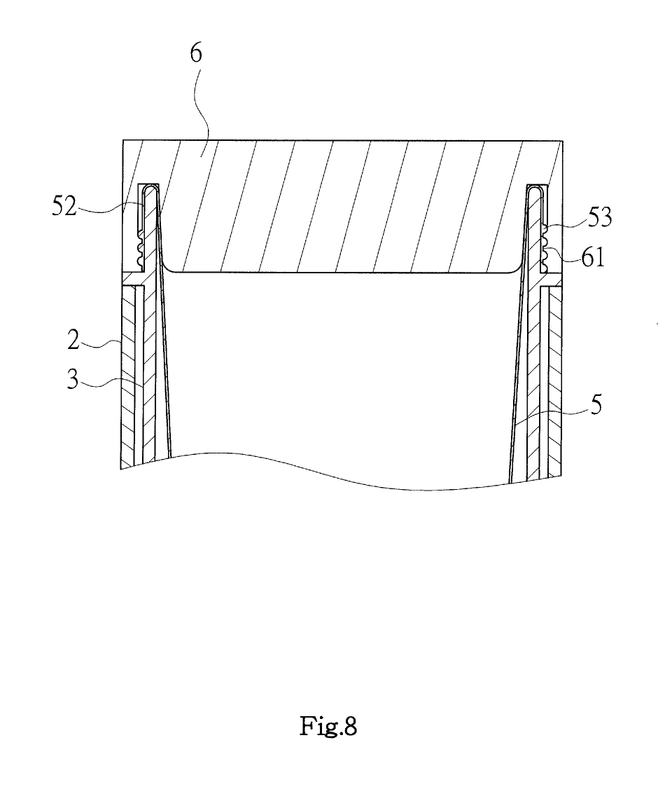

Referring to FIGS. 7 and 8, the container 1 of the present invention, in the embodiment, further includes a cover body 6 separably in combination with the opening of the cup body 5; the combination ways are not limited and all the combination ways capable of sealing the opening 51 of the cup body 5 are within the scope of the present invention. Here, the combination thereof is carried out by means of screwing connection; the outer rim of the engagement portion 52 of the cup body 5 is configured with external threads 53, and internal threads 61 corresponding to the external threads 53 are configured on the cover body 6. Therefore, the inside of the cup body 5 is sealed up when the cover body 6 is in engagement with the cup body 5, allowing the container 1 of the present invention to be a thermos mug.

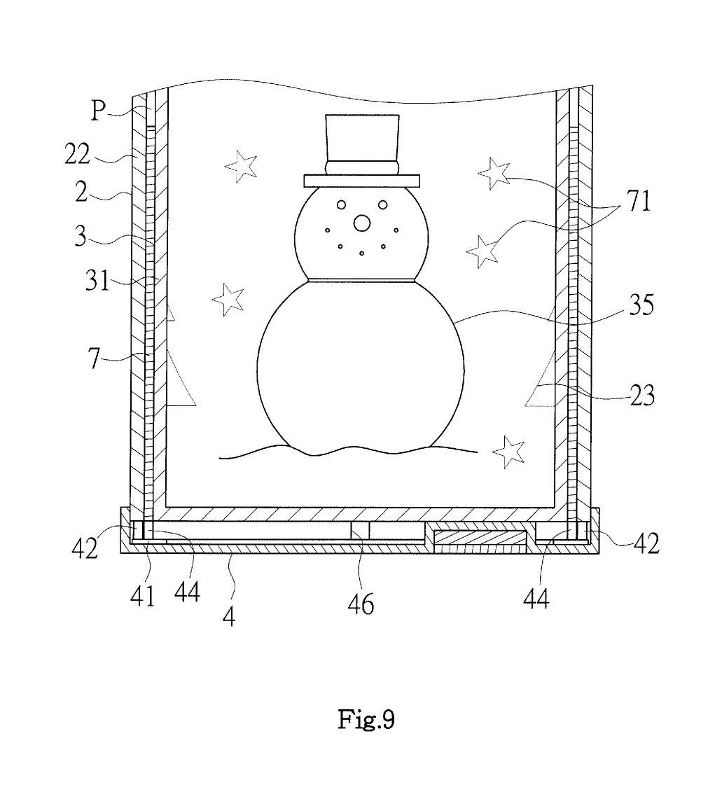

Furthermore, referring to FIG. 9, the wall surface 22 of the outer casing 2 and the wall surface 31 of the inner casing 3 define a passage P configured with a light transmission board 7 surrounding the inner casing 3, on which a pattern 71 is configured, where the pattern 71 is staggered with the first decorative pattern 23 and second decorative pattern 35. Furthermore, the bottom seat 4 is configured with at least one light source 44 corresponding to the bottom of the light transmission board 7, where the light source 44 emits light toward the light transmission board 7, and the light emitting time sequence and color change of the light source 44 are controlled by the control circuit 41 to take turns to flicker with the outer casing 2 and inner casing 3, allowing the present invention to have a brilliant sense of vision so as to promoting the decoration.

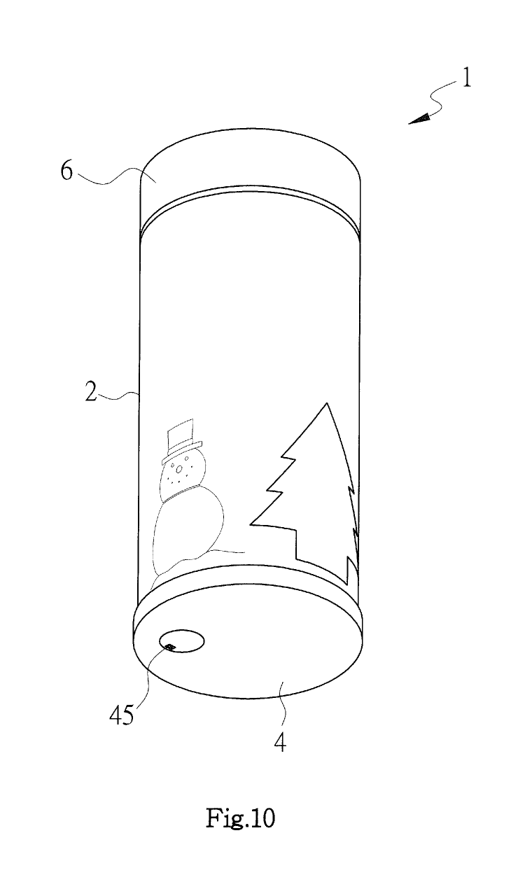

Referring to FIG. 10, the bottom seat 4 further has a switch 5 in electric connection with the control circuit 41 adapted to turn on or off power supply to control the on and off of each light source 42, 44, 46; the switch 45 is the application of a general electronic element so that the details thereof are omitted here.

1: A flashing container, comprising:
an outer casing, being pervious to light, and two sides thereof respectively having an opening, said both openings in communication with each other, and a wall of said outer casing having a wall surface configured with a first decorative pattern;
an inner casing, being hollow and pervious to light, a wall of the inner casing encircling an accommodation space having an upper opening, a wall surface of the wall of the inner casing being configured with a second decorative pattern, and said inner casing fixed inside said outer casing and closing one of said openings of said outer casing; and
a bottom seat, closing said opening on another side of said outer casing and having a control circuit, at least two light sources in electric connection with said control circuit and a power portion supplying power to each said light source, and each said light source corresponding to bottoms of said outer casing and inner casing, and controlled by said control circuit to emit light intermittently toward said outer casing and inner casing;
wherein the control circuit is of an annular configuration mounted in the bottom seat such that an annular upper surface of the control circuit corresponds to bottom ends of the walls of the inner casing and the outer casing.

2: The container according to claim 1, wherein said bottom seat has a switch to turn on or off said power supply.

3: The container according to claim 1, further comprising a cup body having an upper opening, and said cup body in engagement with an inside of said inner casing.

4: The container according to claim 3, further comprising a cover body separably in combination with said opening of said cup body.

5: The container according to claim 1, wherein said wall surface of said outer casing and said wall surface of said inner casing define a passage configured with a light transmission board surrounding said inner casing.

6: The container according to claim 5, wherein said bottom seat is at least configured with an additional light source corresponding to a bottom of said light transmission board.
